(19) United States
(12) Patent Application Publication
(10) Pub. No.: US 2008/0018562 A1
(43) Pub. Date: Jan. 24, 2008

(54) Plasma display panel

(76) Inventors: Eun-Young Jung, Suwon-si (KR); Kyoung-Doo Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/788,131

(22) Filed: Apr. 18, 2007

(30) Foreign Application Priority Data
May 19, 2006 (KR) 10-2006-0045105

(51) Int. Cl. G09G 3/28

(52) U.S. Cl. 345/60

(57) ABSTRACT

Provided is a PDP including a first substrate; sustain electrode pairs, each of which includes a main electrode unit separated from the first substrate, facing each other and elongated on a rear surface of the first substrate, and a plurality of protruding electrode units connecting to the main electrode unit on the same plane as that of the main electrode unit; side walls, which are formed of a dielectric material, disposed on the rear surface of the first substrate and surrounding the sustain electrode pairs while defining a plurality of discharge cells; a second substrate facing the first substrate; a plurality of address electrodes formed on a front surface of the second substrate; a second dielectric layer; barrier ribs defining a space between the first substrate and the second substrate into a plurality of discharge cells; and a phosphor material applied in the discharge cells.

### CROSS-REFERENCE TO RELATED PATENT APPLICATIONS

This application claims the benefit of Korean Patent Application No. 10-2006-0045105, filed on May 19, 2006, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel having improved discharge efficiency with reduced discharge voltage.

2. Description of the Related Art

Plasma display panels (PDPs) that are considered to substitute for conventional cathode ray tubes are flat panel display apparatuses. In PDPs, a discharge gas is filled between two substrates, on which a plurality of electrodes are formed, a discharge voltage is applied to the discharge gas to generate ultraviolet rays, and then, the ultraviolet rays excite phosphor layers formed in a predetermined pattern to emit visible rays and display a desired image.

PDPs can be classified as direct current (DC) PDPs and alternating current (AC) PDPs. In a DC PDP, electrodes are exposed in a discharge space, and thus, charged particles directly move between corresponding electrodes, and discharge current flows while a voltage is applied. Therefore, a resistance for restricting the current must be formed externally. However, in an AC PDP, at least one electrode is covered by a dielectric layer, and the discharge is performed by an electric field formed by wall charges instead of direct movements of the electric charges between the electrodes, and thus, the electric current is limited naturally and the electrodes can be protected from bombardments of ions during discharge. Therefore, the AC PDP has longer life span than that of the DC PDP.

The AC PDPs can be classified as facing discharge type AC PDPs and surface discharge type AC PDPs. In a facing discharge AC PDP, since a phosphor material is applied in order to display colors, the phosphor is degraded due to the ion bombardment, and the life span of the PDP is reduced. Therefore, a surface discharge type AC PDP was suggested by Bell Lab in 1976. The surface discharge type can minimize the degradation of the phosphor due to the ion bombardment during discharge by locating the electrodes generating a display discharge on one side of the discharge cell and locating the phosphor on the opposite side of the electrodes.

FIG. 1 is a view of a surface discharge type AC PDP 100.

Referring to FIG. 1, the conventional surface discharge type AC PDP 100 includes a front substrate 110 showing images to a user, and a rear substrate 120 coupled to the front substrate 110 in parallel to the front substrate 110. Pairs of sustain electrodes, each of which includes an X electrode 111 and a Y electrode 112, are disposed on a rear surface of the front substrate 110, and address electrodes 121 are disposed on a surface of the rear substrate 120, which faces the sustain electrode pairs, so as to cross the electrodes 111 and 112 on the front substrate 110. A first dielectric layer 113 and a second dielectric layer 123 are respectively formed on the sustain electrodes pairs on the front substrate 110 and the address electrodes 121 on the rear substrate 120 in order to embed the electrodes respectively. A protective layer 114 that generally includes MgO is formed on a rear surface of the first dielectric layer 113, and barrier ribs 123 maintaining a discharge distance and preventing an optical cross-talk from generating between discharge cells are formed on a front substrate of the second dielectric layer 123. Red, green, and blue phosphor materials 124 are applied on both side surfaces of the barrier ribs 123, and on the front surface of the second dielectric layer 122, on which the barrier ribs 123 are not formed.

The conventional methods of driving PDP are divided into drives for address discharge and for sustain discharge. The address discharge is generated by a difference between electric potentials of the address electrode 121 and the Y electrode 112, that is, a scan electrode, and wall charges are formed in the address discharge. The sustain discharge, that is, a main discharge for displaying images actually, is generated by a difference between electric potentials of the Y electrode 112, that is, the scan electrode, and the X electrode 111, that is, a common electrode, in the discharge space where the wall charges are formed.

The sustain discharges occurs between the sustain electrodes 111 and 112 and diffuse to a center portion, and then, diffuse to external portions of the sustain electrodes 111 and 112 and is extinguished. The wall charges are not distributed evenly throughout the entire discharge space, but concentrated locally. Therefore, it is difficult to generate the discharge on the outside of the electrodes due to lack of the wall charges, and thus, the discharge hardly occurs throughout the sustain electrodes 111 and 112. Therefore, the discharge voltage increases and the discharge efficiency is reduced. In addition, the address discharge occurring between the address electrodes 121 and the Y electrodes 112 in order to form the wall charges is also delayed.

### SUMMARY OF THE INVENTION

The present embodiments provide a plasma display panel (PDP) that can reduce a discharge voltage, and thus, a discharge efficiency can be improved and a discharge delay can be reduced.

According to an aspect of the present embodiments, there is provided a plasma display panel (PDP) including: a first substrate; sustain electrode pairs, each of which includes a main electrode unit separated from the first substrate, facing each other, and elongated on a rear surface of the first substrate, and a plurality of protruding electrode units connecting to the main electrode unit on the same plane as that of the main electrode unit; side walls, which are formed of a dielectric material, disposed on the rear surface of the first substrate and surrounding the sustain electrode pairs while defining a plurality of discharge cells; a second substrate facing the first substrate with a predetermined distance from the first substrate to form discharge spaces; a plurality of address electrodes formed on a front surface of the second substrate so as to cross the sustain electrode pairs; a second dielectric layer formed on the front surface of the second substrate in order to embed the address electrodes; barrier ribs formed on the front surface of the second dielectric layer in order to define a space between the first substrate and the second substrate into a plurality of discharge cells; and a phosphor material applied in the discharge cells.

The protruding electrode units may be opaque electrodes.

The main electrode units may be disposed in parallel to each other.

The protruding electrode units may protrude straightly from the main electrode unit.

The main electrode unit and the protruding electrode units may cross each other at substantially right angles.

The side walls may be located on the barrier ribs.

The PDP may further include: an additional side wall dividing the discharge cell between the side walls.

The additional side wall may be in parallel to the side walls, in which the main electrode units are embedded, and may be located on an intermediate portion between the side walls.

A sustain electrode embedded in the additional side wall may be a scan electrode.

A distance between the protruding electrode unit embedded in the side wall and the protruding electrode unit embedded in the additional side wall may range from 50 μm to 80 μm.

A distance between the main electrode unit embedded in the side wall and the main electrode unit embedded in the additional side wall may exceed 80 μm.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

FIG. 2 is a partially exploded perspective view of a PDP according to an embodiment;

FIG. 3 is a cross-sectional view of the PDP taken along line III-III of FIG. 2;

FIG. 4 is a plan view of side walls and sustain electrodes taken along line IV-IV of FIG. 4;

FIG. 5 is a partially exploded perspective view of a PDP according to another embodiment;

FIG. 6 is a cross-sectional view of the PDP taken along line VI-VI of FIG. 5; and

FIG. 7 is a plan view of side walls and sustain electrodes taken along line VII-VII of FIG. 5.

### DETAILED DESCRIPTION OF THE INVENTION

The present embodiments will now be described more fully with reference to the accompanying drawings. Like reference numerals in the drawings denote like elements.

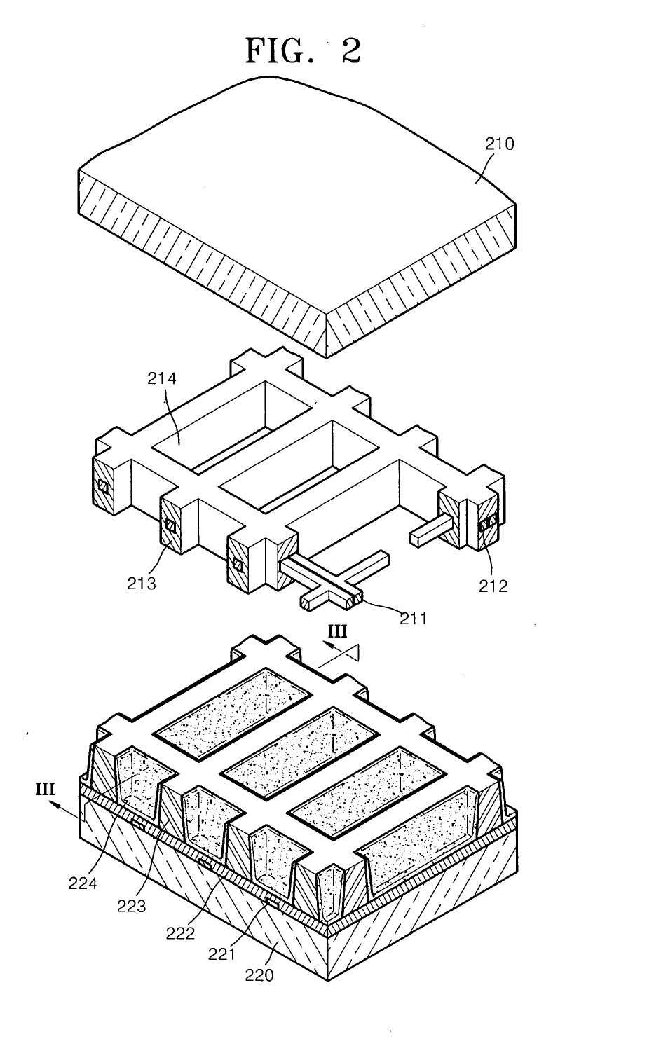

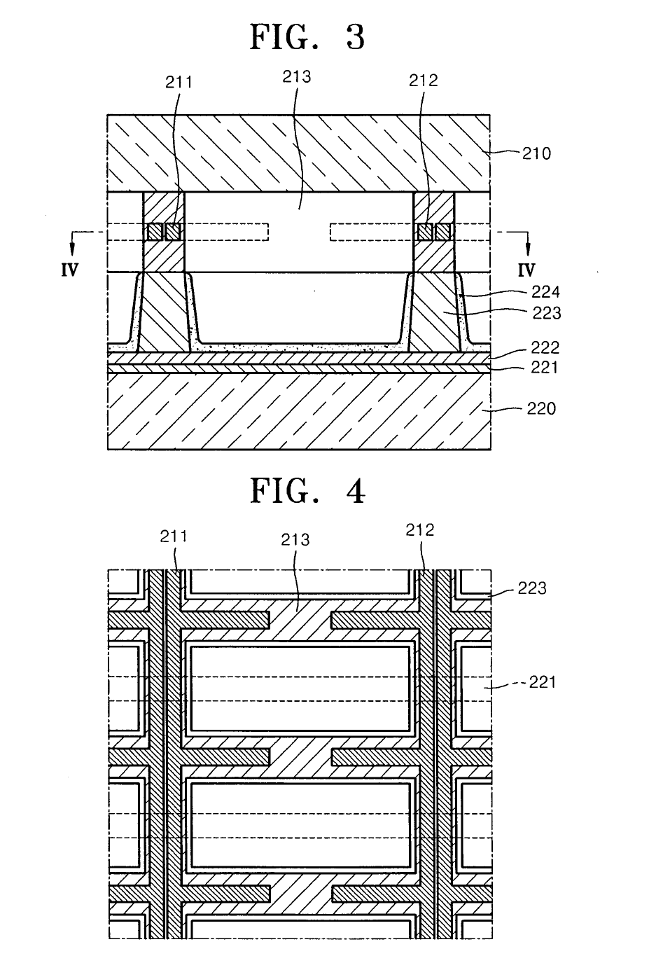

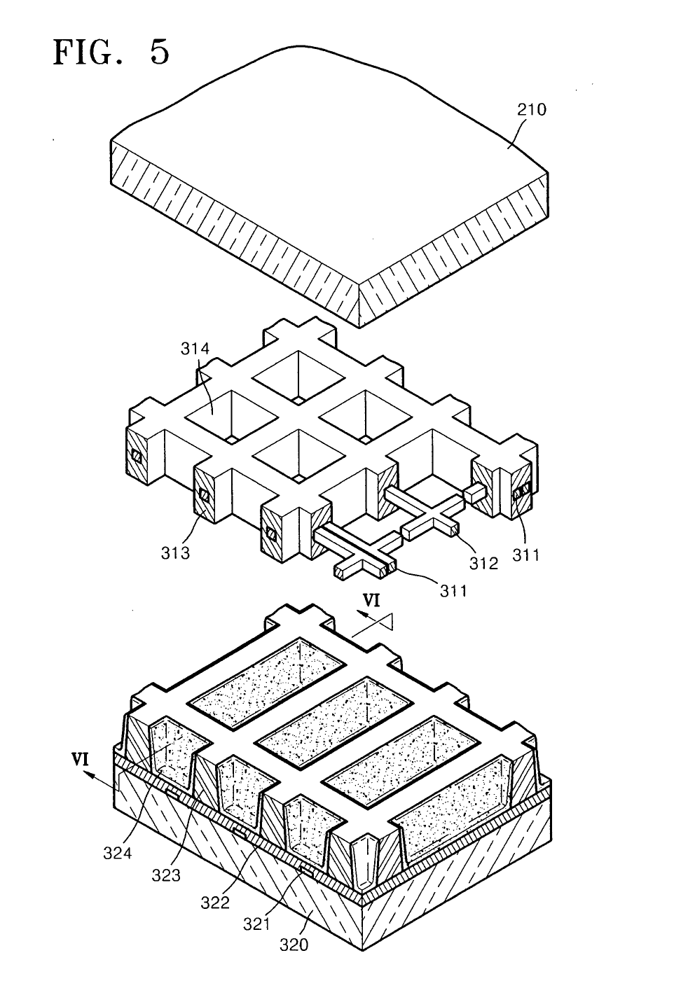

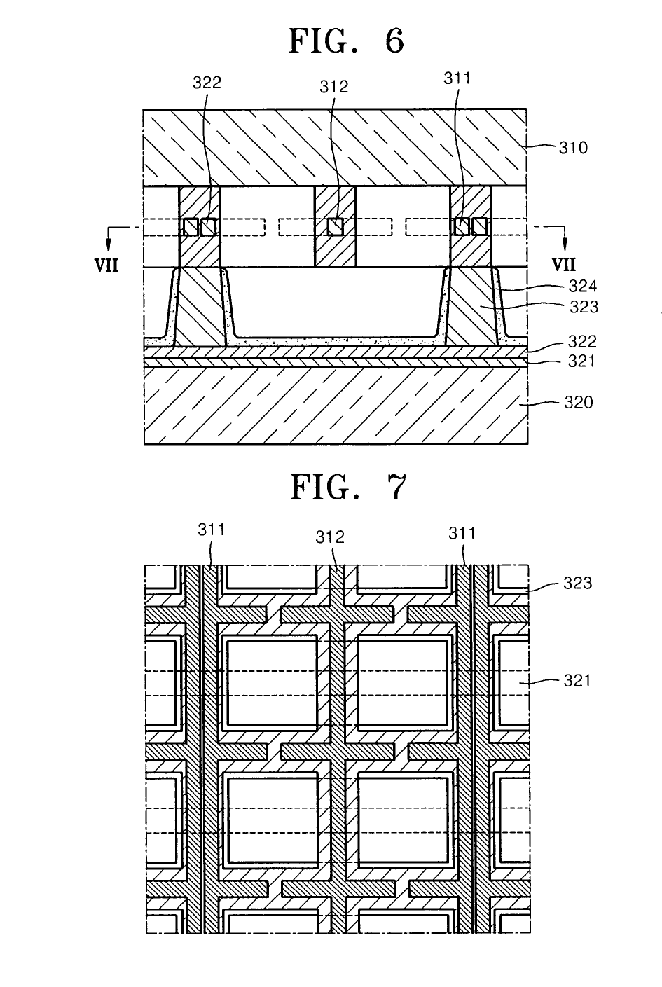

FIG. 2 is a partially exploded perspective view of a plasma display panel (PDP) according to an embodiment, and FIG. 3 is a cross-sectional view of the PDP taken along line III-III of FIG. 2. FIG. 4 is a plan view of side walls and sustain electrodes taken along line IV-IV of FIG. 3, and FIG. 5 is a partially exploded perspective view of a PDP according to another embodiment. FIG. 6 is a cross-sectional view of the PDP taken along line VI-VI of FIG. 5, and FIG. 7 is a plan view of side walls and sustain electrodes taken along line VII-VII of FIG. 5.

Referring to FIGS. 2 through 4, the PDP according to an embodiment includes a front substrate 210, a rear substrate 220, sustain electrode pairs, each of which includes an X electrode 211 and a Y electrode 212, side walls 213 formed of a dielectric material surrounding the sustain electrode pairs between the front substrate 210 and the rear substrate 220, a protective layer 214 surrounding the side walls 213, address electrodes 221, a second dielectric layer 222 embedding the address electrodes 221, phosphor layers 224 applied in discharge cells, barrier ribs 223 defining the discharge cells, and a discharge gas (not shown).

The front substrate 210 can be generally formed of a material having high light transmittance including, for example, glass. The front substrate 210 can be colored by a black material in order to improve a contrast in a lightroom by reducing a reflective brightness. The rear substrate 220 supports the address electrodes 221 and the dielectric layer 222, and can be formed of, for example, glass. The rear substrate 220 is not necessarily formed of a light transmitting material; however, if visible rays generated in the discharge cells are transmitted through the rear substrate 220, the rear substrate 220 can be formed of a material having high light transmittance like the front substrate 210.

On a rear surface of the front substrate 210, the sustain electrode pairs including X electrodes 211 and the Y electrodes 212 are surrounded by the side walls 213 that are formed of a dielectric material. The side walls 213 are formed of the dielectric material in order to prevent the X electrode 211 and the Y electrode 212 from directly conducting with each other, to prevent the sustain electrodes from being damaged due to direct collision of positive ions or electrons, and to accumulate wall charges by inducing electric charges. For example, PbO, B₂O₃, or SiO₂ can be used to form the side walls 213.

Each of the sustain electrode pairs including the X electrodes 211 and the Y electrodes 212 that generate sustain discharge includes a main electrode unit separated from the front substrate 210 and elongated with the X and Y electrodes 211 and 213 facing each other, and a plurality of protruding electrode units protruding from the main electrode unit. The main electrode unit and the protruding electrode units can be formed of various conductive materials and may be formed, for example, of a metal material or a material including ceramics. Examples of metal material are Ag, Pt, Pd, Ni, Cu, and examples of ceramic material are indium doped tin oxide (ITO) and antimony doped tin oxide (ATO). The main electrode unit and the protruding electrode unit of the sustain electrode pair can be formed of the same material or different materials from each other.

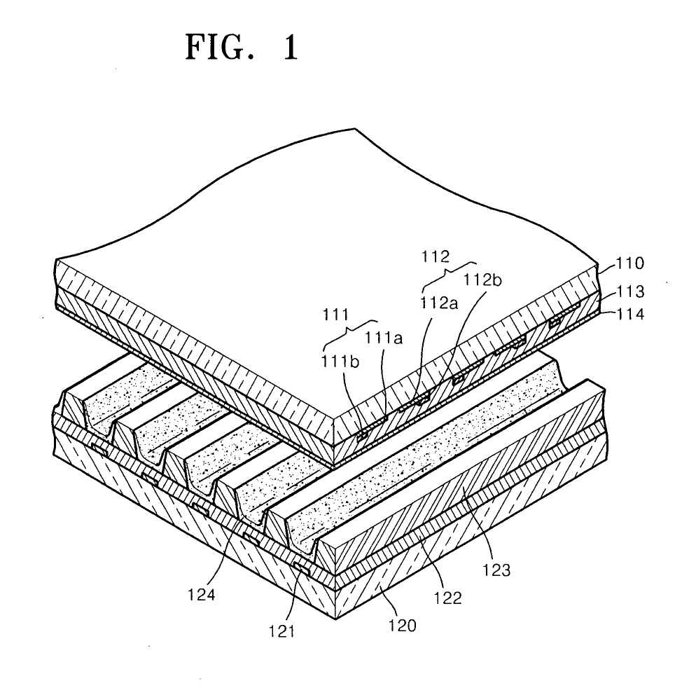

The above sustain electrode pairs are separated from the front substrate 210 unlike the conventional sustain electrode pairs as shown in FIG. 1, and thus, in the case where there is not a protruding electrode, the PDP has the facing discharge structure. However, according to the present embodiments, the protruding electrode units are connected to the main electrode unit on the same surface and surrounded by the side walls formed of the dielectric material, and thus, the surface discharge can occur between the protruding electrode units, as well as the facing discharge occurring between the main electrode units.

In addition, as shown in FIG. 5, additional side walls are located between the side walls embedding the main electrode units in parallel to the side walls, and thus, the distance between the protruding electrode unit embedded in the additional side wall and the existing protruding electrode unit can be reduced, and the surface discharge can occur in two places at the same time. Therefore, it is easy to accumulate the wall charges, and thus, an initiation voltage of the sustain discharge can be lowered to improve the light emitting efficiency of the PDP.

The distance between the protruding electrode units can be from about 50 μm to about 80 μm, and the distance between the main electrode units may exceed about 80 μm.

The side walls 213 formed of the dielectric material in order to surround the sustain electrodes are covered by the protective layer 214, which is can be formed of, for example, MgO. The protective layer 214 prevents the side walls 213 from being damaged due to direct collisions of the positive ions and the electrons onto the side walls 213 during the discharge, and has high light transmittance and emits secondary electrons during the discharge. The protective layer 214 can be formed using a deposition method after forming the side walls 213. A non-vacuum deposition method such as a spray pyrolysis can be used, however, a method using the MgO as a source is generally used. That is, an MgO source is melted using an E-beam method to be deposited, or is sputtered to be deposited.

The address electrodes 221 are arranged on a surface of the rear substrate 220, which faces the front substrate 210, to cross the X electrodes 211 and the Y electrodes 212. The address electrodes 221 generate the address discharge making the sustain discharge between the X electrodes 211 and the Y electrodes 212 easier which can reduce the voltage initiating the main discharge. The address discharge occurs between the Y electrode 212 and the address electrode 221. When the address discharge is terminated, positive ions are accumulated on the Y electrode 212 and electrons are accumulated on the X electrode 211, and thus, the sustain discharge between the X electrode 211 and the Y electrode can occur easily. According to another embodiment shown in FIG. 5, in a case where the Y electrode 312 including the protruding electrode unit is located on the center portion of the discharge cell, a discharge at an angle of about 90° and the facing discharge occur together, and a cross-sectional area of the electrode contributing to the address discharge can increase, and thus, the address discharge voltage can be reduced and a discharge delay can be reduced.

The second dielectric layer 222 (See FIG. 3) is formed on the rear substrate 220 to embed the address electrodes 221. The second dielectric layer 222 is formed of a dielectric material, such as, for example, PbO, B₂O₃, or SiO₂ in order to prevent the address electrodes 221 from being damaged due to the collision of the positive ions or electrons onto the address electrodes 221 during the discharge and induce the electric charges.

Red, green, and blue phosphor layers 224 are formed on the second dielectric layer 222 between the barrier ribs 223 that define the discharge cells, and on side surfaces of the barrier ribs 223. The phosphor layers 224 generate visible rays on receiving ultraviolet rays. The red phosphor layer includes a phosphor material such as Y(V, P)O₄:Eu, the green phosphor layer includes a phosphor material such as Zn₂SiO₄:Mn, and the blue phosphor layer includes a phosphor material such as BAM:Eu.

The barrier ribs 223 are disposed between the front substrate 210 and the rear substrate 220 in order to define the space between the front and rear substrates 210 and 220 into a plurality of discharge cells, in which the discharge occurs. The barrier ribs 223 prevent the optical cross-talk from generating between the discharge cells. According to the current embodiment, each of the barrier ribs 223 includes a longitudinal barrier rib arranged in a direction in which the address electrodes 221 extend and a transverse barrier rib disposed in a direction crossing the longitudinal barrier rib. In addition, the discharge cells have square cross sections. However, the shape of the barrier ribs is not limited thereto, and can be formed in other various types.

In addition, a discharge gas, in which, for example, Ne and Xe are mixed, is filled in the discharge cells. In a state where the discharge gas is filled in the discharge cells, the front substrate 210 and the rear substrate 220 are sealed and coupled to each other by a sealing member formed on edges of the front substrate 210 and the rear substrate 220.

The PDP 200 including the above structure according to the current embodiment operates as follows.

When an address voltage is applied between the address electrodes 221 and the Y electrodes 212 to generate the address discharge, the discharge cells, in which the sustain discharge will occur, are selected. Here, according to the present embodiments, the discharge at the angle of about 90° and the facing discharge are generated at the same time, and the cross sectional area of the electrode contributing to the address discharge is expanded, and thus, the voltage initiating the address discharge can be reduced and the discharge delay can be reduced. After that, the sustain voltage is applied between the X and Y electrodes 211 and 212 in the selected discharge cells, the positive ions accumulated on the Y electrode 212 side and the electrons accumulated on the X electrode 211 side collide with each other to generate the sustain discharge. Then, the voltage pulses applied to the X electrode 211 and the Y electrode 212 are alternated, and thus, the discharge is maintained. The sustain discharge is initiated between the protruding electrode units having the shortest discharge gap, and then, the discharge diffuses along the main electrode units successively. In addition, if the side wall embedding the Y electrode is disposed on the center portion of the discharge cell, the sustain discharge is initiated between the protruding electrode unit of the Y electrode 312 in the side wall of the center portion and the X electrode 311 located on the barrier rib, and then, the discharge diffuses along the main electrode units successively. In addition, since the area of the surface discharge can be increased, a great deal of wall charges can be accumulated in a short time, and thus, the discharge can occur with low voltage.

A the energy level of the discharge gas that is excited during the sustain discharge becomes lower, ultraviolet rays are emitted. The ultraviolet rays excite the phosphor layers 224 applied in the discharge cells. When the energy level of the excited phosphor layer becomes lower, then the visible rays are emitted. The visible rays can then display images. Therefore, the PDP having high discharge efficiency can be formed.

According to the PDP of the present embodiments, the Y electrodes or the scan electrodes, include the protruding electrode units in order to reduce the initiation voltage of the address discharge between the address electrodes and the scan electrodes, and to reduce the discharge delay. In addition, the surface discharge area can be expanded by the Y electrodes disposed on the center portions of the discharge cells, and thus, the initiation voltage of the sustain discharge can be reduced, and the discharge efficiency can be improved.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel (PDP) comprising:
a first substrate;
sustain electrode pairs,
wherein each electrode pair includes a main electrode unit separated from the first substrate,
wherein the electrode pairs face each other, and are elongated on a rear surface of the first substrate;
a plurality of protruding electrode units connected to the main electrode unit on the same plane as that of the main electrode unit;
side walls, which comprise a dielectric material, disposed on the rear surface of the first substrate,
wherein the side walls surround the sustain electrode pairs and define a plurality of discharge cells;
a second substrate facing the first substrate at a predetermined distance from the first substrate;
a plurality of address electrodes formed on a front surface of the second substrate that cross the sustain electrode pairs;
a second dielectric layer formed on the front surface of the second substrate that embeds the address electrodes;
barrier ribs formed on the front surface of the second dielectric layer configured to define the space between the first substrate and the second substrate into a plurality of discharge cells; and
a phosphor material applied in the discharge cells.

2. The PDP of claim 1, wherein the protruding electrode units are opaque electrodes.

3. The PDP of claim 1, wherein the main electrode units are disposed in parallel to each other.

4. The PDP of claim 1, wherein the protruding electrode units protrude straight from the main electrode unit.

5. The PDP of claim 1, wherein the main electrode unit and the protruding electrode units cross each other at substantially right angles.

6. The PDP of claim 1, wherein the side walls are located on the barrier ribs.

7. The PDP of claim 1, further comprising:
an additional side wall dividing the discharge cell between the side walls.

8. The PDP of claim 7, wherein the additional side wall is substantially in parallel to the side walls and is located on an intermediate portion between the side walls.

9. The PDP of claim 8, further comprising a sustain electrode embedded in the additional side wall wherein the sustain electrode is a scan electrode.

10. The PDP of claim 8, wherein a distance between the protruding electrode unit embedded in the side wall and the protruding electrode unit embedded in the additional side wall is from about 50 μm to about 80 μm.

11. The PDP of claim 8, wherein a distance between the main electrode unit embedded in the side wall and the main electrode unit embedded in the additional side wall exceeds about 80 μm.

12. The PDP of claim 1, wherein the side walls comprise at least one of PbO, B₂O₃, and SiO₂.

13. The PDP of claim 7, wherein the additional side wall comprises at least one of PbO, B₂O₃, and SiO₂.

14. The PDP of claim 1, wherein the main electrode unit comprises Ag, Pt, Pd, Ni, Cu, indium doped tin oxide (ITO) antimony doped tin oxide (ATO), or any combination thereof.

15. The PDP of claim 1, wherein the protruding electrode unit comprises Ag, Pt, Pd, Ni, Cu, indium doped tin oxide (ITO) antimony doped tin oxide (ATO), or any combination thereof.

16. The PDP of claim 1, further comprising a protective layer.

17. The PDP of claim 16, wherein the protective layer comprises MgO.

18. The PDP of claim 1, wherein the discharge gas comprises Ne and Xe.

19. The PDP of claim 1, wherein the phosphor material comprises red phosphor material, green phosphor material and blue phosphor material.

20. The PDP of claim 19, wherein the red phosphor comprises Y(V, P)O₄:Eu, the green phosphor layer comprises Zn₂SiO₄:Mn, and the blue phosphor layer comprises BAM:Eu.
